(19) United States
(12) Patent Application Publication
(10) Pub. No.: US 2016/0214466 A1
(43) Pub. Date: Jul. 28, 2016

(54) Arrangement for a Vehicle Roof

(71) Applicant: Webasto SE, Stockdorf (DE)

(72) Inventor: Rupert Kolger, Stockdorf (DE)

(21) Appl. No.: 15/004,071

(22) Filed: Jan. 22, 2016

(30) Foreign Application Priority Data
Jan. 27, 2015 (DE) 10 2015 101121.2

(51) Int. Cl. B60J 3/00; B60J 7/00

(52) U.S. Cl. CPC B60J 3/00; B60J 7/0015; B60J 3/007

(57) ABSTRACT

An assembly for a vehicle roof comprises a cover, which is embodied to close off an opening in the vehicle roof. The cover has an outer layer, which faces away from the vehicle interior, an inner layer, which faces the vehicle interior, and a solar cell layer, which is arranged between the outer layer and the inner layer. The assembly further has a darkening device, which is assigned to the cover and which has a reflective layer which, in a closed state, faces the inner layer so as to reflect light that enters through the cover in the direction of the vehicle interior back in the direction of the cover.

The present invention relates to an assembly for a vehicle roof which comprises a solar cell layer.

In some motor vehicles, a roof opening which is closed off by a cover, particularly made of glass, is integrated into the vehicle roof to allow occupants to see out of the motor vehicle. The cover is optionally embodied as displaceable, to enable an exchange of air as desired, in addition to allowing the roof to be seen through. Some motor vehicles also have solar elements that are designed to convert solar energy to electric energy.

When solar elements are integrated into a vehicle roof or a cover for a vehicle roof, for example, it cannot be seen through, or can at least be seen through only with severe limitation due to the wafer-based solar cell technology. Solar cell layers and protective films which are located in such a solar element, for instance, are largely opaque in terms of the range of the electromagnetic spectrum that is visible to humans.

It is an object of the invention to devise an assembly for a vehicle roof that is suitable for converting solar energy to electric energy and for enabling the roof to be seen through.

According to a first aspect of the invention, an assembly for a vehicle roof comprises a cover, which is designed to close off an opening in the vehicle roof, said cover having an outer layer, which faces away from the vehicle interior, an inner layer, which faces the vehicle interior, and a solar cell layer, which is arranged between the outer layer and the inner layer. The assembly further comprises a darkening device, which is assigned to the cover and which has a reflective layer which, in a closed state, faces the inner layer of the cover so as to reflect any light that enters through the cover in the direction of the vehicle interior back in the direction of the cover.

In this manner, an assembly having a cover for a vehicle roof is achieved, which enables solar energy to be converted to electric energy in a simple manner, while at the same time allowing the cover to be seen through. The solar cell layer comprises solar cells that are arranged in such a way that incident light that does not strike any solar cells is able to enter the vehicle interior, resulting in homogeneous transparency. Alternatively or additionally, the solar cells are themselves transparent, so that solar energy can be converted to electric energy and at the same time, light can enter the vehicle interior.

When the darkening device is partially or completely closed and is therefore partially or completely covering the cover in the vehicle roof from the direction of the vehicle interior, the described assembly increases the efficiency of the energy conversion of solar energy to electric energy. Light that is transmitted through the cover and has passed the solar cells in the solar cell layer is deflected back onto the solar cell layer by the reflective layer of the darkening device, and can thus further contribute to energy conversion.

The solar cell layer of the cover is designed to be capable of converting solar energy to electric energy from at least two sides. For example, flat solar cells, the upper and lower sides of which have sensitive layers for converting solar energy to electric energy, are arranged in the solar cell layer. In this context, upper and lower sides refer to the sides of the solar cells which, in a mounted state, face toward or away from the vehicle interior. For example, the lower sides face the vehicle interior. Alternatively or additionally, the solar cell layer has spherical solar cells, the entire surface of which is sensitive to the absorption and conversion of light.

Due to the characteristic that the solar cell layer is capable of absorbing solar energy and converting it to electric energy on multiple sides, the described assembly results in an advantageous combination of cover and light-reflecting darkening device which allows light to pass through the see-through cover while also achieving greater efficiency in the conversion of solar energy to electric energy than would be possible if the solar cell layer were sensitive to light incidence on only one side. The described assembly therefore enables an efficient generation of electric energy while at the same time achieving a transparency function.

According to one embodiment of the first aspect, the reflective layer is embodied as a reflective surface of the darkening device.

A simple option for achieving a reflective function by means of the darkening device is described in this manner. For example, the darkening device has a sunroof shade, the upper side of which has a reflective surface, and which in a closed state faces the vehicle roof and therefore the cover, so that the upper side reflects transmitted light back to the solar cell layer in a simple manner.

According to a further embodiment of the first aspect, the reflective layer comprises a reflective fabric.

This embodiment of the assembly describes a further option for achieving a reflective function by means of the darkening device, in which the darkening device comprises a roller shade material made of a reflective fabric, for example. Such fabrics are reflective fibers or reflective textiles, for example, which reflect the spectrum of transmitted light that can be used by the solar cell layer back to the cover and therefore back to the solar cell layer.

According to a further embodiment of the first aspect, the reflective layer comprises a reflective film which is arranged on the surface of the darkening device.

Such an embodiment of the assembly describes a simple and cost-effective option for achieving a reflective function of the darkening device, thereby enabling efficient energy conversion of solar energy to electric energy. For example, the darkening device has a sunroof shade or a roller shade, the upper side of which is laminated with a reflective film. The upper side refers, for example, to a direction which, when the darkening device is in a mounted and closed state in the vehicle, faces away from the vehicle interior and faces toward the cover.

When a view through the cover is desired, for example, the darkening device can be left in an opened state in which it is displaced or rolled up, for example, in a rear area of the vehicle. When it is desired for the light passing through the cover to also be converted to electric energy, the darkening device will be closed, causing the solar cell layer of the cover to be irradiated with light from both sides. Alternatively, in one operating state the darkening device can be only partially closed, allowing a portion of the incident light to be transmitted into the vehicle interior, for example, and enabling the cover to be seen through, while at the same time allowing another portion of the incident light to be used for energy conversion.

According to a further embodiment of the first aspect, the solar cell layer comprises spherical solar cells.

This embodiment of the assembly describes a possible configuration of the solar cell layer. Spherical or spheral solar cells have a surface that is uniformly sensitive to incident light and can therefore be used over their entire surface for converting solar energy to electric energy. For example, the spherical solar cells have a diameter of up to 2 mm, the active solar cell material of which is made of silicon. In other embodiments of the assembly, the spherical solar cells have different diameters and/or the active layer that is sensitive for solar conversion is made of a different material. In addition, combinations of different geometries and materials of the spherical solar cells are also possible.

A solar cell layer that comprises spherical solar cells can be described, for example, as a ball grid, in which the spherical solar cells are arranged side by side. The solar cells are connected to one another, for example, by a very thin wire or an electrically transparent conductive structure to allow the electric energy that is generated by light absorption to be channeled off.

According to a further embodiment of the first aspect, the solar cell layer comprises flat solar cells.

This embodiment of the assembly describes a further possible configuration of the solar cell layer of the cover. In this case the flat solar cells have at least two sides that are sensitive to incident light. For example, the upper side of a flat solar cell faces away from the vehicle interior and the lower side of the flat solar cell faces the vehicle interior, so that when light passes through the cover from an exterior region in the direction of the vehicle interior, solar energy is converted to electric energy on both sides by means of the described solar cell layer. The portion of light that passes through the solar cell layer and propagates in the direction of the vehicle interior can be deflected by means of the reflective darkening device back to the solar cell layer and can therefore be available to the lower side of the flat solar cells for energy conversion.

According to a further embodiment of the first aspect, the solar cell layer comprises organic solar cells.

This embodiment of the assembly also describes a further possible configuration of the solar cell layer. In organic solar cells or organic photovoltaics, the active solar cell layer of the respective solar cell is transparent and thus allows light to be converted to electric energy while simultaneously making the layer see-through and/or transparent.

It is further possible for the assembly to comprise both spherical and flat solar cells, which may be organic or inorganic. Combinations and embodiments having solar cells of different geometries and materials are also possible in various embodiments of the assembly, so that the cover can be transparent while at the same time, solar energy can be efficiently converted to electric energy.

According to a further embodiment of the first aspect, the darkening device comprises a roller shade.

According to a further embodiment of the first aspect, the darkening direction comprises a sunroof shade.

According to a further embodiment of the first aspect, the outer layer and/or the inner layer of the cover comprise films and/or glass.

This embodiment of the assembly describes a simple option for configuring the cover for the vehicle roof, in which said cover has a glass and/or film substrate, for example, as the outer layer and the inner layer, thus enabling a simple and cost-efficient cover comprising a solar cell layer.

According to a further embodiment of the first aspect, the cover is movable relative to the vehicle roof.

In this connection, it should be noted that the cover is not necessarily embodied merely to close off the opening in the vehicle roof, and may instead also be embodied as movable relative to the vehicle roof. For example, the cover may be a roof window which can be opened and closed, and which comprises the solar cell layer.

In the following, embodiment examples of the invention will be specified in greater detail in reference to the set of schematic drawings. The drawings show:

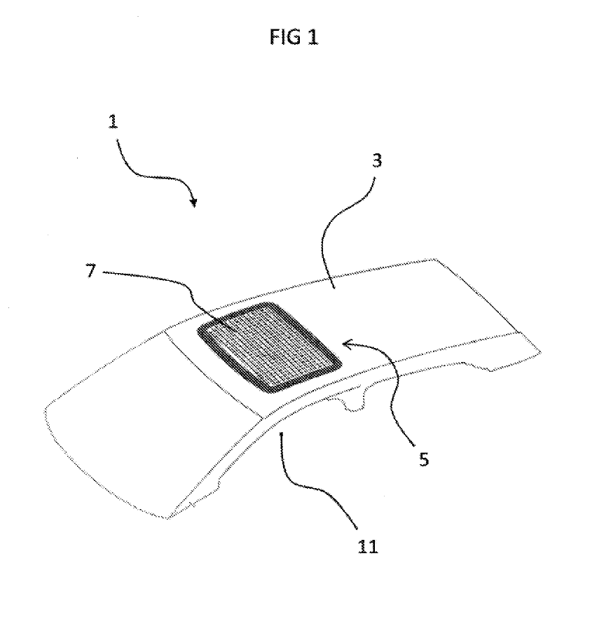

FIG. 1 an embodiment example of an assembly for a vehicle roof,

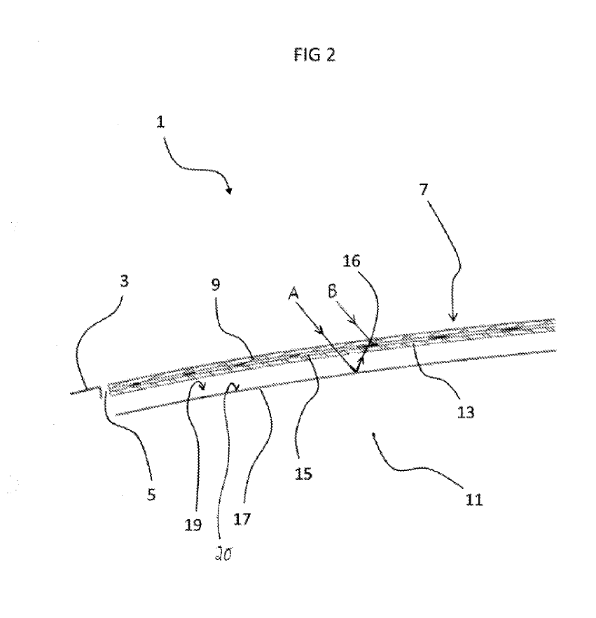

FIG. 2 an embodiment example of an assembly for a vehicle roof from a side view,

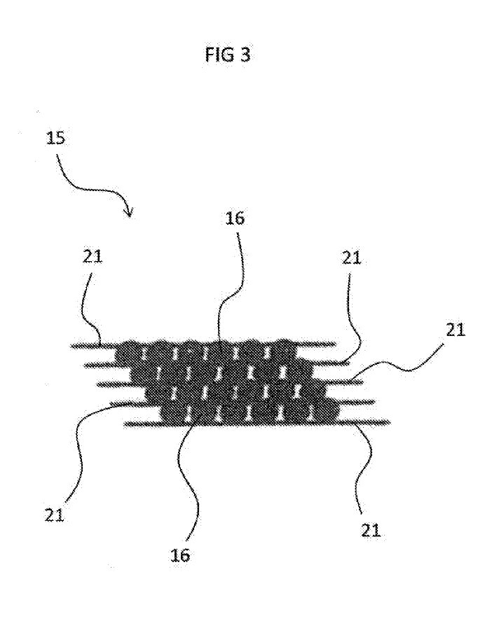

FIG. 3 an embodiment example of a solar cell layer for a vehicle roof

Elements of similar design and function are denoted by the same reference signs in all of the figures.

FIG. 1 shows an assembly 1 for a vehicle roof 3, which comprises a cover 7 which is designed to close off an opening 5 in vehicle roof 3. Cover 7 has an outer layer 9, an inner layer 13 and a solar cell layer 15, which is arranged between outer layer 9 and inner layer 13. Cover 7 and particularly solar cell layer 15 are configured such that solar energy can be converted to electric energy, and such that it is possible to see into or out of a vehicle interior 11 through cover 7.

Assembly 1 further comprises a darkening device 17, which is assigned to cover 7 and which has a reflective layer 19, which, in a closed state, faces inner layer 13 of cover 7 so as to reflect any light that enters through cover 7 in the direction of vehicle interior 11 back in the direction of cover 7 and thus in the direction of solar cell layer 15. For example, reflective layer 19 is arranged as a reflective film on an upper side of darkening device 17, the upper side referring to the side of darkening device 17 that faces away from vehicle interior 11 when darkening device 17 is in a closed state. Alternatively or additionally, reflective layer 19 is embodied as a reflective fabric, which forms a part of a roller shade or sunroof shade. For example, a reflective roller shade material is used for a roller shade as part of darkening device 17.

Solar cell layer 15 is embodied such that it is capable of converting solar energy to electric energy on both sides, for example. The term both sides is used to describe, for example, an upper side and a lower side of the solar cell layer, wherein the upper side faces away from vehicle interior 11 and the lower side faces vehicle interior 11. This is beneficial, for example, if solar cell layer 15 comprises flat solar cells 16.

The portion of light that passes through solar cell layer 15 and propagates in the direction of vehicle interior 11 can be deflected by means of reflective darkening device 17 back to solar cell layer 15 and can therefore be made available to the lower side of flat solar cells 16 for the purpose of energy conversion. In further embodiments of assembly 1, solar cell layer 15 comprises spherical and/or organic solar cells 16. The layer of organic solar cells 16 that is active for solar conversion is optionally itself transparent and therefore enables solar energy to be converted to electric energy while simultaneously making the assembly see-through or transparent. In the case of spherical solar cells 16, for example, the entire surface is sensitive for the absorption and conversion of light.

However, assembly 1 can also comprise both spherical and flat solar cells 16. Solar cells 16 may be organic or inorganic. Combinations and embodiments having solar cells 16 of different geometries and materials are also possible in embodiments of assembly 1.

Assembly 1 therefore achieves a conversion of solar energy to electric energy and allows cover 7 to be seen through in a simple manner. The term solar energy in this context describes not only radiant energy within the spectral range that is visible to the human eye, but can also comprise radiant energy in the infrared and/or ultraviolet range and/or other frequency ranges.

Solar cells 16 of solar cell layer 15 are arranged and/or embodied, for example, such that incident light that does not strike or is not absorbed by solar cells 16 is allowed to enter vehicle interior 11, resulting, for example, in homogeneous transparency.

For example, when darkening device 17 is partially or completely closed and is therefore partially or completely covering cover 7 in vehicle roof 3 from the direction of vehicle interior 11, the described assembly 1 increases the efficiency of the conversion of solar energy to electric energy. Light that is transmitted through cover 7 and passes solar cells 16 in solar cell layer 15 is deflected back to solar cell layer 15 by reflective layer 19 of darkening device 17 and can thus contribute further to energy conversion.

FIG. 2 shows a sectional illustration of one embodiment example of assembly 1, representing a side view of the embodiment example of assembly 1 of FIG. 1, by way of example. In the view shown, it is clear that cover 7 has outer layer 9, inner layer 13 and between outer layer 9 and inner layer 13, solar cell layer 15. Furthermore, solar cell layer 15 in this embodiment example has flat solar cells 16.

The embodiment example shown in FIG. 2 shows cover 7 and darkening device 17 in a closed state. Cover 7 thus closes off opening 5 in vehicle roof 3. Cover 7 can be embodied as movable relative to vehicle roof 3 in order to partially or fully uncover opening 7 as a roof window, for example.

Darkening device 17 of assembly 1 has a surface 20 which in the closed state faces cover 7 and therefore solar cell layer 15. This enables incident light that is transmitted through outer layer 9, through solar cell layer 15 and through inner layer 13 to be reflected back in the direction of cover 7 and thereby enable further energy conversion of solar energy to electric energy. A reflective film or a reflective fabric, which enables the reflection of the incident light, is arranged on surface 20 of darkening device 17, for example.

Illustrated by way of example are two incident light beams A and B, the direction of incidence of said beams from an exterior region in the direction of vehicle interior 11 being indicated by arrows. Light beam B passes through outer layer 9 and is absorbed, for example, by the upper side of a solar cell 16 of solar cell layer 15 and converted to electric energy. Light beam A, in contrast, passes through cover 7 and reaches vehicle interior 11. Light beam A then strikes surface 20 and is reflected by reflective layer 19 of darkening device 17, and is conducted back in the direction of cover 7 and solar cell layer 15. Reflected light beam A then strikes the back side of a solar cell 16, which absorbs said beam and converts it to electric energy.

A simple configuration for assembly 1 is thereby achieved, in which a cover 7 for vehicle roof 3 comprises solar cell layer 15, which in this embodiment example enables the energy conversion of solar energy to electric energy on both sides, while at the same time making said cover transparent and see-through. When darkening device 17 is in an opened state, it is displaced to or rolled up in a rear region of the motor vehicle, for example. Alternatively, darkening device 17 can also be partially opened or closed such that a portion of the incident light is reflected by reflective layer 19 while another portion of the light enters vehicle interior 11 without being reflected in the direction of the cover.

Outer layer 9 represents an outer layer of cover 7 and inner layer 13 represents an inner layer of said cover, for example. Outer layer 9 and/or inner layer 13 comprise glass and/or film substrates, for example, in particular plastic film substrates, and thus enable a cost-effective and simple design of cover 7 and assembly 1. Solar cell layer 15 is arranged between outer layer 9 and inner layer 13 and achieves an embedded layer, so to speak, in which solar cells 16 are embedded. For example, spherical and/or flat and/or organic solar cells 16 are embedded in ethylene vinyl acetate (EVA) or polyvinyl butyral (PVB). Additional materials or combinations of materials in solar cell layer 15 are also possible.

FIG. 3 shows a plan view of one embodiment example of solar cell layer 15, which comprises a plurality of current collectors 21 and spherical solar cells 16. Spherical solar cells 16 are coupled to at least one current collector 21 for channeling off the electric energy that is converted from solar energy. As is clear from the embodiment example of FIG. 3, light that enters from the outside, for example, and does not strike a spherical solar cell 16 is transmitted through solar cell layer 15 and, when darkening device 17 is in a closed state, is accordingly reflected back in the direction of cover 7 by means of reflective layer 19. The back sides of the spherical solar cells 16 shown enable further absorption of the reflected light and therefore further conversion to electric energy.

Solar cell layer 15 can be described as a ball grid, for example, in which spherical solar cells 16 are arranged side by side along a grid line. The grid lines are embodied as current collectors 21, for example, each configured as a very thin wire or as an electrically transparent conductive structure, for example, for channeling off the converted electric energy that is enabled by light absorption. As a whole, solar cell layer 15 shown is a mesh having a homogeneous, transparent structure.

The embodiment of assembly 1 shown describes a possible configuration of solar cell layer 15 with spherical solar cells 16, the entire surface of which can be sensitive to incident light. Thus the entire surface of solar cells 16 can be used for converting solar energy to electric energy. For example, spherical solar cells 16 have a diameter of up to 2 mm, the active solar cell material of which is made of silicon. In other embodiments of assembly 1, spherical solar cells 16 have a different diameter and/or the active layer that is sensitive to solar conversion is made of a different material.

In addition, combinations of different geometries and materials of spherical solar cells 16 and combinations of different solar cells 16 are also possible in order to achieve a transparent solar cell layer 15. For example, solar cell layer 15 comprises thin film solar cells 16, in which a desired transparency is achieved by means of laser structures.

As compared with an assembly that does not comprise a transparent solar cell layer 15 and a reflective darkening device 17, a more efficient output of convertible solar energy and thus a more energy efficient assembly 1, which also entails a transparency function and allows the assembly to be seen through, is thereby achieved.

1. An assembly for a vehicle roof, comprising
a cover, which is embodied to close off an opening in the vehicle roof, wherein the cover has an outer layer, which faces away from the vehicle interior, an inner layer, which faces the vehicle interior, and a solar cell layer, which is arranged between the outer layer and the inner layer, and
a darkening device, which is assigned to the cover and which has reflective layer which, in a closed state, faces the inner layer so as to reflect light that enters through the cover in the direction of the vehicle interior back in the direction of the cover.

2. The assembly according to claim 1,
in which the reflective layer is a reflective surface of the darkening device.

3. The assembly according to claim 1,
in which the reflective layer comprises a reflective fabric.

4. The assembly according to claim 1,
in which the reflective layer comprises a reflective film, which is arranged on the surface of the darkening device.

5. The assembly according to claim 1,
in which the solar cell layer comprises spherical solar cells.

6. The assembly according to claim 5,
in which the solar cell layer comprises flat solar cells.

7. The assembly according to claim 1,
in which the solar cell layer comprises organic solar cells.

8. The assembly according to claim 1,
in which the darkening device comprises a roller shade.

9. The assembly according to claim 1,
in which the darkening device comprises a sunroof shade.

10. The assembly according to claim 1, in
which the outer layer and/or the inner layer of the cover comprise films, in particular plastic films, and/or glass.

11. The assembly according to claim 1,
in which the cover is movable relative to the vehicle roof.
